(19) United States
(12) Patent Application Publication
(10) Pub. No.: US 2025/0325058 A1
(43) Pub. Date: Oct. 23, 2025

(54) ARTICLE OF APPAREL HAVING MULTIPLE THERMAL REGULATORY ZONES

(71) Applicant: LULULEMON ATHLETICA CANADA INC., VANCOUVER (CA)

(72) Inventors: OLGA VYSOTSKA, VANCOUVER (CA); SOPHIE ADRIENNE DOYLE, VANCOUVER (CA); MATTHEW PHILIP CROCKER, VANCOUVER (CA); SISI JIANG, VANCOUVER (CA); DAN ANDREI CRISTIAN BUS, VANCOUVER (CA)

(21) Appl. No.: 18/855,376

(22) PCT Filed: Apr. 10, 2023
(86) PCT No.: PCT/CA2023/050488

§ 371 Date: Oct. 9, 2024

Related U.S. Application Data
(60) Provisional application No. 63/330,126, filed on Apr. 12, 2022.

(51) Int. Cl. A41D 27/28; A41D 31/06; A41D 31/12; D04B 1/16; D04B 1/24; D04B 21/16

(52) U.S. Cl. CPC A41D 27/28; A41D 31/065; A41D 31/125; D04B 1/16; D04B 1/24; D04B 21/16

(57) ABSTRACT

Examples of an article of apparel with two or more thermal zones are described. The article of apparel comprises at least one first thermal zone and at least one second thermal zone. The at least one first thermal zone comprises an outer fabric layer having a low moisture regain and a knitted inner liner positioned underneath and separated from the outer fabric layer so that the knitted inner liner is facing a wearer when worn. The at least one second thermal zone comprises a knitted fabric layer with an inner side facing the wearer being brushed. The at least one first thermal zone is positioned in a part of the article of apparel significantly exposed to the elements and configured to provide higher thermal comfort to the wearer than the at least one second thermal zone.

This application claims priority from and the benefit of the filing date of U.S. Provisional Patent Application No. 63/330,126, filed Apr. 12, 2022, and the entire content of such application is incorporated herein by reference.

### FIELD

This application relates to the field of apparel, and more specifically, to an article of apparel having multiple thermal regulatory zones.

### BACKGROUND

Apparel or clothing has many functions including protecting a wearer from the elements, weather, and external environmental conditions (e.g., rain, wind, snow, humidity, temperature, etc.). Another function of clothing, and particularly athletic clothing, is to assist the human body in regulating its temperature.

It is well known and documented that human performance in work or athletic competition is dependent upon maximal muscle efficiency, which can be achieved by a combination of several factors including: 1) homeostatic temperature; 2) homeostatic pH range; 3) sufficient energy; 4) sufficient oxygen; and, 5) sufficient blood circulation.

The human body, and more specifically human muscle tissue, is able to convert stored energy in the form of glucose into kinetic energy through cellular processes. These cellular processes require the presence of oxygen which is transported from the lungs to muscle cells through blood circulation. Maximizing these cellular processes also depends on the pH level.

Accordingly, of the five factors mentioned above, four of the five are related to the biological process of converting stored energy into kinetic energy and cannot be readily controlled by an individual.

Of the five factors, homeostatic temperature of the body can be readily controlled by an individual. Common methods of controlling homeostatic temperature include controlling the ambient temperature of the environment and controlling the temperature of the body by removing layers of clothing or putting on extra layers of clothing.

The human body can sweat profusely to cool itself during exercise and heat exposure, and is able to fine-tune body temperature in moderate environments through variations in skin circulation. In cooler environments, blood flow to the extremities and skin can be reduced. Conversely, the human body can increase heat production by shivering and by increasing the insulating air layer around the skin by piloerection.

In U.S. Pat. No. 5,636,380, thermoregulatory apparel is disclosed. The thermoregulatory apparel includes panels which enhance the skin's ability to dissipate or retain heat as necessary to maintain a constant body temperature. Such apparel includes pants, shorts, stockings, body suits, wraps, gloves, leggings, and the like. The apparel includes heat retention panels and heat dissipation panels strategically placed throughout the apparel. Heat dissipation panels increase the skin's ability to evaporate perspiration by wicking moisture (i.e., perspiration) away from the skin, while heat retention panels increase the skin's ability to maintain and develop heat in the muscles. However, problems and disadvantages remain with existing thermoregulatory apparel.

### SUMMARY OF THE APPLICATION

Embodiments of the invention generally relate to articles of clothing or apparel having the ability to thermoregulate the human body. More specifically, such apparel can have one or more thermal zones, wherein a first thermal zone can comprise an outer layer having a low moisture regain, and wherein a second thermal zone can comprise a knitted fabric layer.

In a broad aspect of the invention, an article of clothing or apparel can have areas of thermal regulating zones. The article of apparel can comprise at least one first thermal zone and at least one second thermal zone, wherein the at least one first thermal zone is positioned in an area of the apparel that is exposed to the environment or elements. In some embodiments, the at least one first thermal zone is adapted to provide higher thermal comfort than that of the at least one second thermal zone.

In one aspect, at least one first thermal zone comprises an outer fabric layer that has a low moisture regain and a knitted inner liner positioned underneath and separated from the outer fabric layer so that the knitted inner liner is facing a wearer when worn. At least one second thermal zone is joined to the first thermal zone and comprises a knitted fabric layer.

In one aspect, the outer fabric layer is an outer composite fabric layer that comprises a knitted face layer, a knitted back layer, and at least one middle layer having a low moisture regain fused between the knitted face layer and the knitted back layer of the outer composite fabric layer. The knitted face layer of the outer composite fabric layer comprises a durable water repellency (DWR) additive finishing. The at least one middle layer in the outer composite fabric layer comprises an elastic polyurethane (PU) membrane.

In another aspect, the outer fabric layer is an outer woven fabric layer. The outer woven fabric layer comprises a durable water repellency (DWR) additive finishing.

In one aspect, the knitted inner liner of the first thermal zone and the knitted fabric layer of the second thermal zone is a same fabric material knitted seamlessly as a single knitted panel and comprises two or more compression zones integrated therein.

In one aspect, the article of clothing or apparel is a tight or tights with the first thermal zone positioned in at least a pelvic area and at least a portion of a front tights or groin area of the tights. The knitted fabric liner and/or the knitted fabric layer comprise at least one gripping yarn knitted with the yarns of the knitted fabric liner and/or the knitted fabric layer to form at least one gripping area on a surface of the tights facing the wearer when worn.

In another aspect, the article of clothing or apparel is a jacket with the first thermal zone positioned at least in a shoulder area, a front torso area, at least a portion of an upper back area, and at least a portion of an upper arm area of the jacket.

In yet another aspect, the article of clothing or apparel is a short or shorts with the first thermal zone positioned in at least a pelvic area and in at least a portion of front leg areas of the shorts and at least a portion of a back of the shorts covering a behind area.

In addition to the aspects and embodiments described above, further aspects and embodiments will become apparent by reference to the drawings and study of the following detailed description.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the application. Sizes and relative positions of elements in the drawings are not necessarily drawn to scale. For example, the shapes of various elements and angles may not be drawn to scale, and some of these elements may be arbitrarily enlarged and positioned to improve drawing legibility.

FIG. 1A is a cross-sectional detail view of an example article of apparel illustrating at least one first thermal zone and at least one second thermal zone.

FIG. 1B is a cross-sectional detail view of an outer fabric layer of the at least one first thermal zone of the example article of apparel of FIG. 1A.

FIG. 2A is a front view of an example article of apparel having at least one first thermal zone and at least one second thermal zone.

FIG. 2B is a rear view of the article of apparel of FIG. 2A.

FIG. 2C is a side view of the article of apparel of FIG. 2A.

FIG. 3A is a front view of an example article of apparel having at least one first thermal zone and at least one second thermal zone.

FIG. 3B is a side view of the article of apparel of FIG. 3A.

FIG. 3C is a rear view of the article of apparel of FIG. 3A.

FIG. 4A is a front view of an example article of apparel having at least one first thermal zone and at least one second thermal zone.

FIG. 4B is a rear view of the article of apparel of FIG. 4A.

FIG. 5A is a front view of an example article of apparel having at least one first thermal zone and at least one second thermal zone.

FIG. 5B is a side view of the article of apparel of FIG. 5A.

FIG. 5C is a rear view of the article of apparel of FIG. 5A.

FIG. 6 is a front detail view of an inner side of a hem band of an example article of apparel.

FIG. 7A is a top view of a portion of an engineered knitted fabric layer of the example articles of apparel of FIGS. 2 and 3 illustrating a back leg area and a knee area.

FIG. 7B is a top view of a portion of an engineered knitted inner liner of the example articles of apparel of FIGS. 2 and 3 illustrating a front tight or groin area.

FIG. 8 is a top view of an example engineered knitted fabric layer of the example article of apparel of FIGS. 2 and 3.

FIG. 9A is a top view of an example front engineered knitted fabric layer of a leg portion of the example article of apparel of FIGS. 2 and 3.

FIG. 9B is a top view of an example back engineered knitted fabric layer of a leg portion of the example article of apparel of FIGS. 2 and 3.

FIG. 10A is a top view of an example portion of an engineered knitted inner liner and knitted fabric layer of a back of the example article of apparel of FIG. 4B.

FIG. 10B is a top view of an example portion of an engineered knitted inner liner and knitted fabric layer of a sleeve of the example article of apparel of FIG. 4A.

### DETAILED DESCRIPTION

In the following description, details are set forth to provide an understanding of the application. In some instances, certain structures, techniques, and methods have not been described or shown in detail in order not to obscure the application.

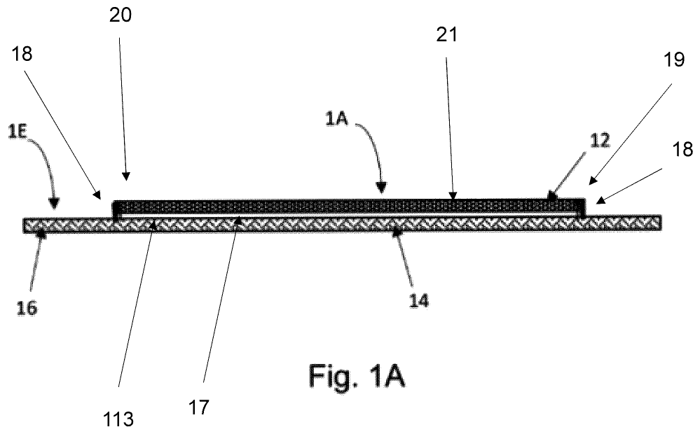

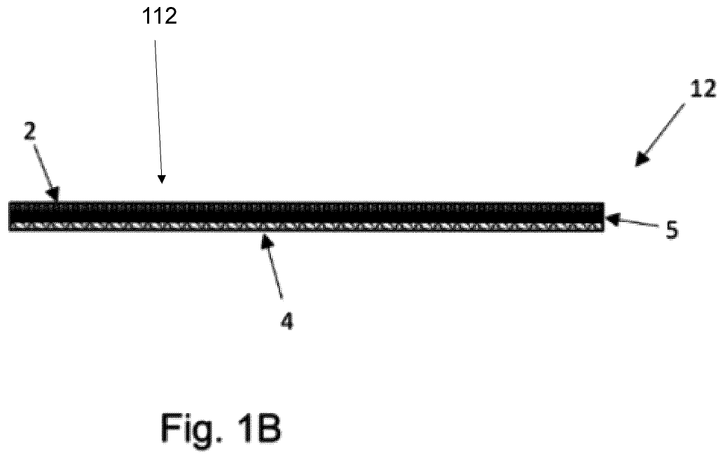

With reference to FIGS. 1A to 6, embodiments of the application can comprise an article of apparel (e.g., 100) having two or more thermal zones (or thermal regulatory zones or thermal regulating zones). The article of apparel 100 can comprise at least one first thermal zone (e.g., 1A, 1B, 1C) and at least one second thermal zone (e.g., 1E).

As shown in the drawings, the at least one first thermal zone 1B, IC can comprise an outer fabric layer (or panel) 12 having a low moisture regain and a knitted inner liner (or panel) 14 (see FIGS. 1A and 1B). For reference, moisture regain refers to the amount of moisture that a material, fabric, or fiber is able to reabsorb after it has dried. In embodiments, the knitted inner liner 14 can be positioned underneath and separated or otherwise spaced apart 17 from the outer fabric layer 12, such that the knitted inner liner 14 is facing a wearer, that is, between the skin of the wearer and the outer fabric layer 12. The inner side of the knitted inner liner 14 that faces the wearer can be brushed.

In embodiments and as shown, the at least one second thermal zone 1E can further comprise a knitted fabric layer (or panel) 16 having an inner side facing the wearer. In embodiments, the knitted fabric layer 16 in the second thermal zone 1E is continuous and integrated with the knitted inner liner 14 of the first thermal zone (e.g., 1A). The inner side of the knitted fabric layer 16 that faces the wearer can be brushed.

With specific reference to the drawings, the at least one first thermal zone can be positioned in an area of the article of apparel 100 that is exposed to the outside environment and to the elements (or weather or weather elements). In embodiments, these areas of the apparel 100 that are exposed can be areas that are significantly exposed to the elements. In further embodiments, the at least one first thermal zone 1B, 1C can be adapted and/or configured to provide higher thermal comfort to the wearer than the at least one second thermal zone 1E.

With reference to FIG. 1B, in embodiments, the outer fabric layer 12 of the at least one first thermal zone 1B, IC can comprise a composite three layered fabric that includes a knitted face or front layer 2, a knitted back layer 4, and at least one middle layer 5 fused between the knitted face layer 2 and the knitted back layer 4. The middle layer 5 can be a microporous fabric or material with pores that are small enough to prevent liquid (e.g., water) molecule penetration but large enough to allow vapor to pass through. In some implementations, the middle layer 5 can be a polymer-based film, membrane, or coating. In embodiments, the at least one middle layer 5 can be an elastic polyurethane (PU) membrane. Persons skilled in the art would understand that the middle layer 5 can be any other suitable film, coating, membrane, or microporous fabric with high resistance to water penetration without departing from the scope of the application.

In embodiments, the knitted face layer 2 of the outer composite fabric layer 12 can be a weft or warp knitted fabric comprising a first yarn and a second yarn. The first yarn can be a synthetic polymer, a natural fiber, a regenerated cellulosic fiber, or a blend of natural or regenerated cellulosic fibers with synthetic fibers. The second yarn can be an elastane and the knitted face layer 2 can be configured to stretch in a weft direction and/or in a warp direction. In embodiments, the knitted face layer 2 of the outer composite fabric layer 12 can comprise a durable water repellency (DWR) additive and/or a DWR additive finishing. The DWR additive finishing can comprise nonfluorinated chemicals (non-PFC). For example, the first yarn and/or second yarn of the knitted face layer 2 in the outer composite fabric layer 12 can comprise a DWR additive and/or a DWR additive finishing. The knitted back layer 4 of the outer composite fabric layer 12 can be a weft or warp knitted fabric comprising a third yarn and a fourth yarn. The third yarn can be a synthetic polymer, a natural fiber, a regenerated cellulosic fiber, or a blend of natural or regenerated cellulosic fibers with synthetic fibers. The fourth yarn can be an elastane yarn and the knitted back layer 4 can be configured to stretch in a weft direction and/or in warp direction. In embodiments, the knitted back layer 4 of the outer composite fabric layer 12 can comprise a DWR additive and/or a DWR additive finishing, or the third yarn and/or the fourth yarn can comprise a DWR additive and/or a DWR additive finishing.

In embodiments, the outer fabric layer 12 can be a woven fabric. The outer woven fabric layer 12 can further comprise at least one elastic warp yarn and at least one elastic weft yarn so that it can stretch in a weft direction and/or in a warp direction. In embodiments, the outer fabric layer 12 can be closely woven fabric. The woven outer fabric layer 12 can be coated or laminated with a water resistant coating or membrane to prevent water penetration.

In embodiments, the outer fabric layer can also comprise a durable water repellency (DWR) additive and/or a DWR additive finishing.

In embodiments, the knitted inner liner 14 and the knitted fabric layer 16 can be a weft or warp knitted fabric comprising a fifth yarn and a sixth yarn. The fifth yarn can be a synthetic polymer, a natural fiber, a regenerated cellulosic fiber, or a blend of natural or regenerated cellulosic fibers with synthetic fibers. The sixth yarn can be an elastane yarn and the knitted inner liner 14 and the knitted fabric layer 16 can be configured to stretch in a weft direction and/or in a warp direction. In embodiments, the knitted inner liner 14 and/or the knitted fabric layer 16 can comprise a knit stitch jacquard construction with an elastane jacquard added to the knit stitch construction. In embodiments, the knitted inner liner 14 and/or the knitted fabric layer 16 can be engineered to comprise two or more compression zones seamlessly knitted together. The engineered knitted inner liner 14 and/or the knitted fabric layer 16 can be knitted using a raschel knitting machine, such as for example, the Rascheltronic™ 4/2 jacquard raschel warp knitting machine available form Karl Mayer Holding GmbH & Co. KG, which has two jacquard guide bars. The two jacquard guide bars can be used for seamlessly knitting different compression zones. For example, one of the guide bars may be used to provide a desired combination of stitches and knit constructions forming ground knit constructions or jacquard artwork patterns. Different levels of compression zones within the ground knit constructions can be obtained by changing the yarns, stitches, and/or the knit constructions. For example, one of the bars can seamlessly knit a first knit construction which can be, for example, a Jersey knit in a first zone and a second knit stitch construction, which can be, for example, a dense dot knit in a second zone. The second jacquard guide bar can be used to add an elastane jacquard knit construction to each of the first and/or the second knit constructions/patterns knitted by the first bar or can be completely independent of any other jacquard construction thus creating zones of different power levels within the fabric. The jacquard elastane construction provided by the second jacquard bar is an independent jacquard knit or artwork pattern from the ground construction or artwork pattern provided by the first bar in, for example, the first and second knit stitch construction zones. The elastane jacquard knit construction/pattern added by the second guide bar is an added (independent) jacquard construction which can additionally create and change compression properties (e.g., density, thickness, weight, etc.) of the fabric in a particular zone, such as the first and second zones created by the first jacquard bar, such that numerous different compression zones can be provided. The different levels of compression of the compression zones may be provided by combining jacquard knitting with jacquard patterns to provide a double effect with respect to compression. Ventilation zones with, for example, mesh textures may also be provided. The mesh textures may be used to provide lower compression and ventilation zones in selected areas. Different levels of elastane content (or similar synthetic fibers or yarn such as Spandex™, Lycra™, polyamide, polyether-polyurea copolymer, etc.) may be engineered into the fabric of the inner liner 14 and/or the knitted fabric layer 16 to provide different compression zones.

Referring again to FIG. 1A, in one embodiment the knitted inner liner 14 of the at least one first thermal zone (e.g., 1A, 1B, IC) can be the same fabric or material as the fabric in the knitted fabric layer 16 of the at least one second thermal zone (e.g., 1E). In embodiments, the knitted inner liner 14 and the knitted fabric layer 16 can be knitted seamlessly as a single knitted panel (as described further below). In embodiments, the outer fabric layer 12 of the at least one first thermal zone can overlay the knitted inner liner 14 in the at least one first thermal zone 1B, IC. The outer fabric layer 12 can be attached (e.g., connected, joined, bonded, sewn, etc.) to the underlying knitted inner liner 14 such that the knitted inner liner 14 is separated or otherwise spaced apart 17 from the outer fabric layer 12. The outer fabric layer 12 can be attached to the knitted inner liner 14 by sewing 18 along at least one side 19, 20 of the outer fabric layer 12. In some embodiments, the outer fabric layer 12 can be sewn/bonded to the knitted inner liner 14 such that each side 19, 20 of the outer fabric layer 12 is attached to the knitted inner liner 14 underneath the outer fabric layer 12. In some embodiments, the outer fabric layer 12 can be attached to the knitted inner liner 14 such that one side (e.g., 21) of the outer fabric layer 12 is free floating (or free hanging) (i.e., not connected to the underlying knitted inner liner 14) forming a slit opening 113 (as further described below) so that air can flow between the outer fabric layer 12 and the underlying knitted inner liner 14. Control of air flow in the spacing 17 between the outer fabric layer 12 and knitted inner liner 14 (e.g., by opening and closing the slit opening 113, etc.) provides improved temperature and moisture control for the article of apparel 100.

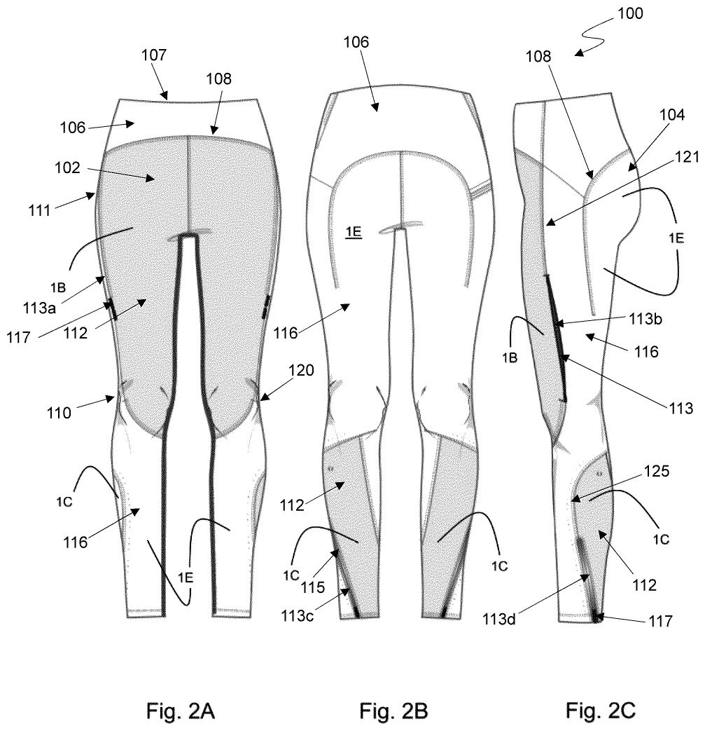

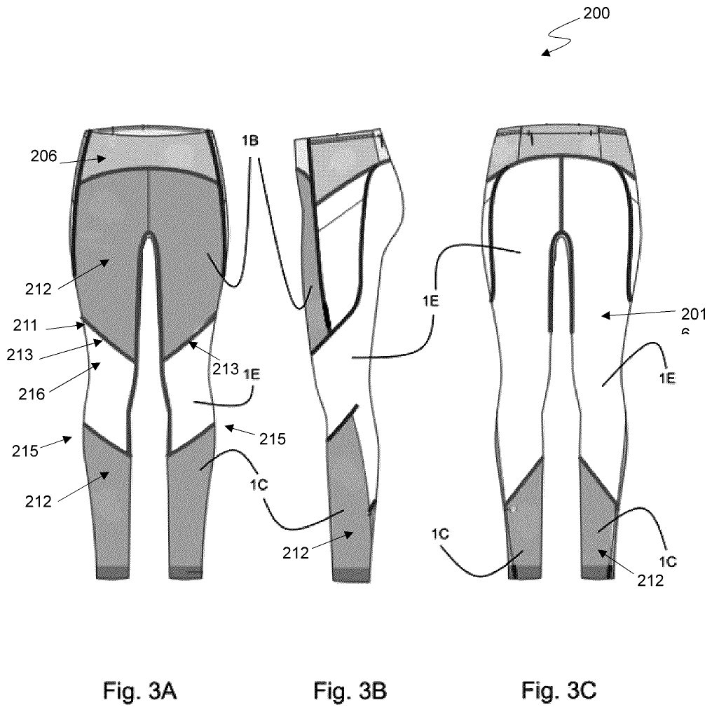

FIGS. 2A to 3C show an embodiment of the article of apparel 100, 200 that can be tights, leggings, or yoga pants. As shown, the at least one first thermal zone 1B, IC can be located (or positioned) in at least a pelvic area (shown as 1B) and at least a portion of a front tights or groin area (also shown as 1B). In some embodiments, the at least one first thermal zone 1B, IC is also located in at least part of a calf area (shown as 1C) and/or at least part of a shin area (shown as IC) (see FIGS. 3A to 3C). FIGS. 2A to 2C illustrate an embodiment of the article or apparel 100, such as tights, leggings, or yoga pants. The article of apparel 100 comprises a front portion 102 for covering a pelvis (i.e., groin, lower abdomen, and front of the thighs) portion of a wearer, a back portion 104 for covering a behind (i.e., buttocks, lower back, and back of the thighs) portion of the wearer, a waistband 106 having a top edge 107 forming a waist opening and a bottom edge 108 attached to the front and back portions 102, 104, a first (or right) leg portion 110 configured to cover a right leg of the wearer, and a second (or left) leg portion 120 configured to cover a left leg of the wearer. Each of the first and the second leg portions 110, 120 of the article of apparel 100 has a front leg part and a back leg part which can be attached along at least one side forming at least one side seam. The outer fabric layer 12 in the at least one first thermal zone 1B, IC of the article of apparel 100 can comprise a composite three layered fabric layer (or panel) 112 as described above (i.e., the knitted face or front layer 2, knitted back layer 4, and middle layer 5). The composite outer fabric layer 112 of the article of apparel 100 can be attached to the knitted inner liner 14, as described above, such that there is a space 17 formed between the composite outer fabric layer 112 and the underlying knitted inner liner 14. In some embodiments, at least one side (e.g., 21) of the composite outer fabric layer 112, or in some embodiments a portion of one side 21 of the composite outer fabric layer 112, may not be attached to the underlying knitted inner liner 14 forming a slit opening 113 so that air can flow between the outer fabric layer 112 and the underlying knitted inner liner 14. For example, FIGS. 2A to 2C show a first slit opening 113a formed along a portion of a first side seam 111 of the first thermal zone 1B at the first (right) leg portion 110, a second slit opening 113b formed along a portion of a second side seam 121 of the first thermal zone 1B at the second (left) leg portion 120, a third slit opening 113c formed along a portion of a first back side seam 115 of the first thermal zone 1C of the first (right) leg portion 110, and a forth slit opening 113d formed along a portion of a second back side seam 125 of the first thermal zone 1C of the second (left) leg portion 120. In some embodiments, one or more of the slit openings 113a, 113b, 113c, 113d can be closable using a fastener 117, such as for example, a zipper, button, snap button, or any other suitable fastener. In some embodiments, some of the outer fabric panels 112 of the article of apparel 100 can be completely attached to the underlying knitted inner liner 14 (i.e., all sides 19, 20, 21 of the outer fabric panel 112 are sewn to the underlying knitted inner liner 14) while some of the outer fabric panels 112 of the article of apparel 100 can have at least one side 21 or a portion of the one side 21 not connected to the knitted inner liner 14 to form the slit opening 113.

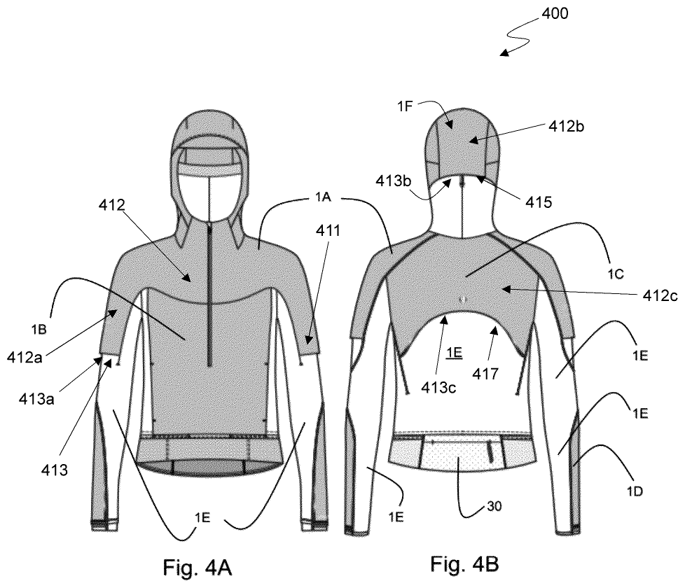

An article of apparel 200 as shown in FIGS. 3A to 3C can also be tights, leggings, or yoga pants similar to the article of apparel 100 shown in FIGS. 2A to 2C. In embodiments of the article of apparel 200, the outer fabric layer 12 in the at least one first thermal zone 1B, IC can comprise a woven outer fabric layer (or panel) 212 (see FIG. 4A, etc.), which can be attached to the underlying knitted inner liner 14 by sewing along the sides (e.g., 19, 20) of the woven fabric panel 212. For example, each side 19, 20 of the woven fabric panel 212 of the woven outer layer 212 can be sewn to the underlying knitted fabric liner 14. In some embodiments, at least one side (e.g., 21) or a portion of one side 21 of the woven outer fabric layer 212 may not be connected to the underlying knitted inner liner 14 forming a slit opening 213 so that air can flow between the outer fabric layer 212 and the underlying knitted inner liner 14. For example, a bottom side 211 of the woven outer fabric panel 212 in the first thermal zone 1B can be free floating (i.e., not attached to the underlying knitted inner liner 14) thus forming an air flow slit opening 213 in each of the front leg portions 215 of the article of apparel 200. The article of apparel 100, 200 can further include a gripping surface formed at least on a portion of an inner surface of the waistband 106, 206 to prevent slippage or rolling down of the waistband and the apparel 100, 200.

In some embodiments of the tights 100, 200 shown in FIGS. 2 and 3, the outer fabric layer in some of the at least one first thermal zone 1B, IC (e.g., zone 1B) can be a composite outer fabric layer 112, while in others of the at least one first thermal zone 1B, IC (e.g., zone 1C) the outer fabric layer can be a woven fabric layer/panel 212.

With reference to FIGS. 4A and 4B, in another embodiment, the article of apparel can be a jacket 400. As shown, the at least one first thermal zone 1A, 1B, IC, ID, IF can be located in at least a shoulder area (shown as 1A), a front torso area (shown as 1B), at least a portion of an upper back area (shown as 1C), and at least a portion of an arm area (shown as 1D). In embodiments, an additional first thermal zone IF can be located in a head covering area (shown as IF). The at least one first thermal zone 1A, 1B, IC, ID, IF can comprise an outer fabric layer 412 that can be a woven fabric layer or a composite fabric layer as described above (see FIG. 1A, etc.). The outer fabric layer 412 can be attached to the underlying knitted inner liner 14 along all of its sides (e.g., 19, 20, 21) or at least one of its sides (e.g., 21) can be free floating (not attached to the underlying knitted inner liner 14) thus forming an air flow slit opening 413 as described above. For example, as shown in FIGS. 4A and 4B, a bottom side 411 at an upper sleeve portion of the shoulder part of the outer fabric layer 412a can be free floating forming a first slit opening 413a so that air can flow between the sleeve outer fabric panel 412a and the underlying knitted inner liner 14 in the upper arm portion of the article of apparel 400. FIG. 4B further shows a second slit opening 413b formed at the back of the hood by a free floating back side 415 of the hood's outer fabric layer 412b and a third slit opening 413c formed at the back of the article of apparel 400 by a free floating bottom side 417 of the back outer fabric layer 412c. The article of apparel 400 can further include a gripping surface or area 50 at least on a portion of an inner surface of sides of a hem band 30 to keep the bottom of the apparel 400 closer to the body of the wearer.

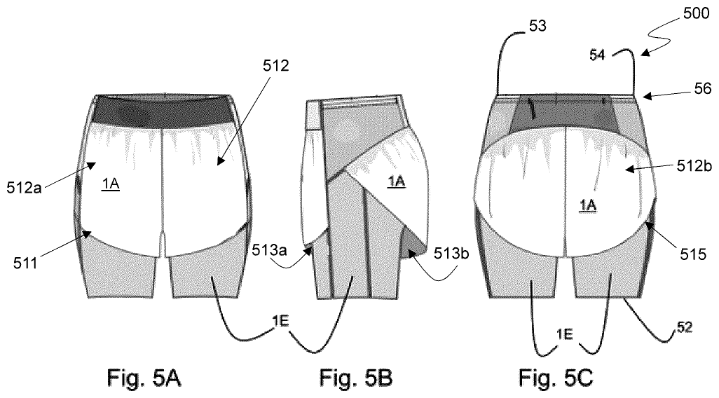

With reference to FIGS. 5A to 5C, another embodiment of the article of apparel 500 can be shorts. As shown, the at least one first thermal zone 1A can be located in at least the pelvic area, at least a portion of front leg areas, and/or a portion of a back of the shorts covering the behind area (all shown as 1A). The second thermal zone 1E can be located in at least a portion of the leg areas (shown as 1E). The at least one first thermal zone 1A can comprise an outer fabric layer 512 that can be a woven fabric layer or a composite fabric layer as described above. The outer fabric layer 512 can be attached to the underlying knitted inner liner 14 such that bottom sides 511 of the front outer fabric layer 512a and a bottom side 515 of the back outer fabric layer 512b are free floating thus forming corresponding air flow openings 513a, 513b as described above.

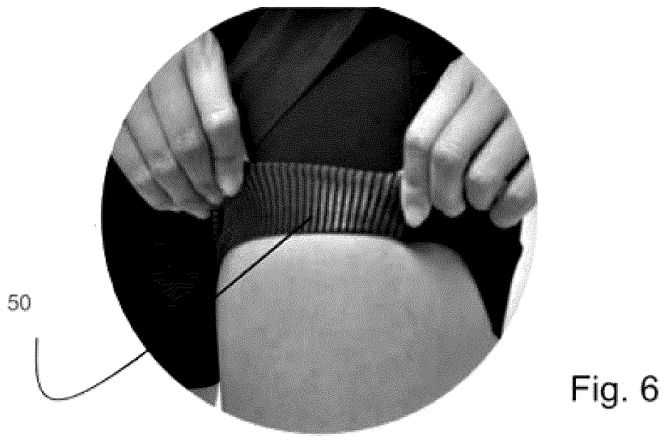

With reference to FIGS. 5A, 5B, 5C, and 6, at least one gripping area 50 can be provided and positioned proximate to each leg opening 52 of the shorts (or the tights) 500 on an inner side facing the body of the wearer. In some embodiments, the gripping area 50 can be provided on the left and right sides 53, 54 of the waistband 56 on the inner side facing the wearer. In some apparel, such as for example the jacket 400 shown in FIGS. 4A and 4B, the gripping area 50 can be positioned on a back inner side and on the inner sides of the hem band 30. The gripping area 50 can comprise at least one gripping yarn knitted with the yarns of the knitted fabric liner and/or the knitted fabric layer such that it forms the gripping area 50 on an inner surface facing the wearer when worn. The gripping area 50 secures the fit of the article of apparel during activity, such as preventing part of the article of apparel from moving, for example, a legging hem moving up a leg of the wearer or a waistband sliding down the waist of the wearer.

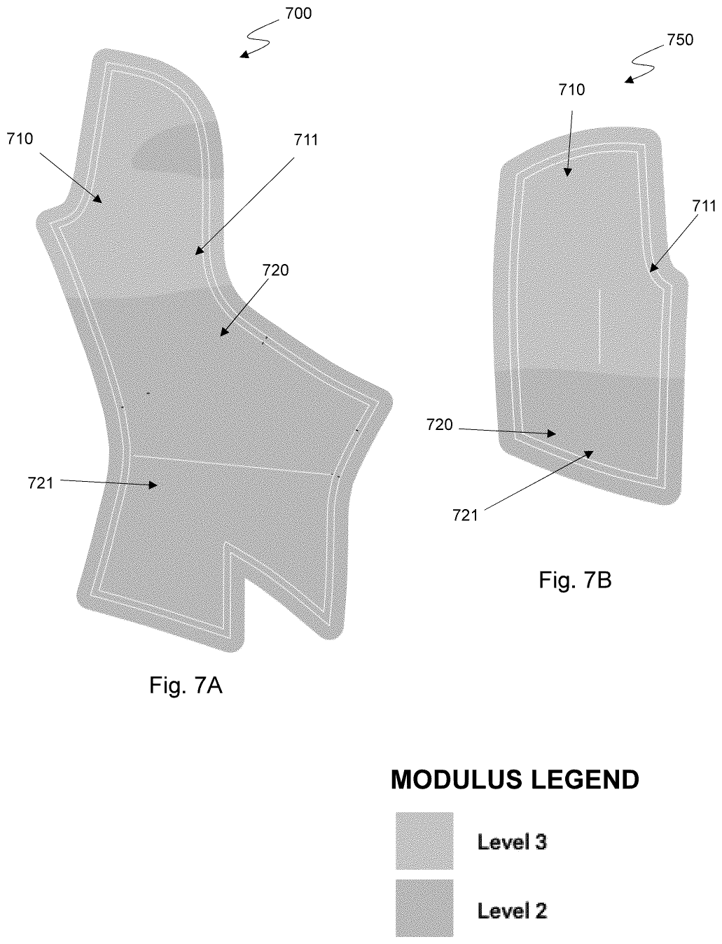

As described above, the knitted inner liner 14 that is underneath the outer fabric layer 12 in the at least one first thermal zone 1B and IC and/or the knitted fabric layer 16 in the least one second thermal zone 1E can be engineered to comprise two or more compression zones. FIGS. 7 to 9 show examples of at least a portion of the knitted inner liner 14 and/or the knitted fabric layer 16 which are part of tights, leggings, or yoga pants 100, 200. The knitted inner liner 14 and the knitted fabric layer 16 can be seamlessly knitted as a single knitted panel (e.g., 700, 750). As shown in FIGS. 7A and 7B, in an embodiment, the knitted panels 700, 750 can comprise a first compression zone 710 having a first knit stitch construction (or pattern) 711 that may have a first amount of compression (or compressive modulus) (e.g., “Level 3”) and a second compression zone 720 attached to the first compression zone 710 by a scam or a seamless transition which may have a second knit stitch construction (or pattern) 721. The second compression zone 720 may have a second amount of compression (or compressive modulus) (e.g., “Level 2”). According to one embodiment, the first amount of compression of the first compression zone 710 may be greater than the second amount of compression of the second compression zone 720. That is, the first compression zone 710 may provide a tighter or more compressive fit than the second compression zone 720. The knitted panel 700 shown in FIG. 7A shows the first compression zone 710 that may be positioned at an upper part of the back of the legs while the second compression zone 720 may be positioned at the back and front knee areas (see FIGS. 3A to 3C). The knitted panel 750 shown in FIG. 7B is an example of the knitted liner 16 (underneath the fabric layer 12) positioned at the front tight or groin area.

According to one embodiment, the first and second knit stitch constructions 711, 721 of the first and second compression zones 710, 720 of the article of apparel 100 may be the same. According to one embodiment, at least one of the first and second knit stitch constructions 711, 721 may be a jacquard pattern. For example, the first knit stitch construction 711 may include an elastane jacquard construction (or pattern) that is added to the first knit stitch construction 711. According to one embodiment, an amount (or extent) of the elastane jacquard in the first knit stitch construction 711 may be greater than an amount (or extent) of the elastane jacquard in the second knit stitch construction 721.

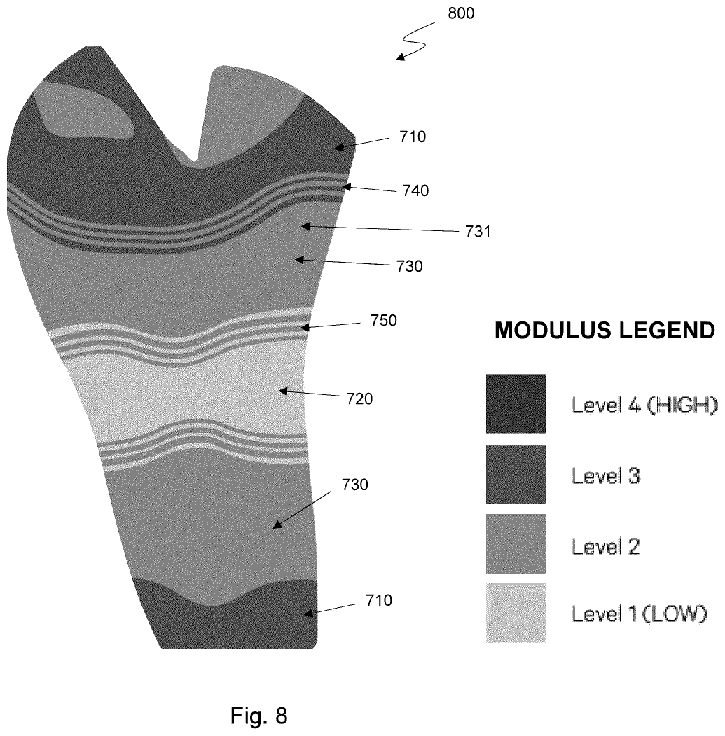

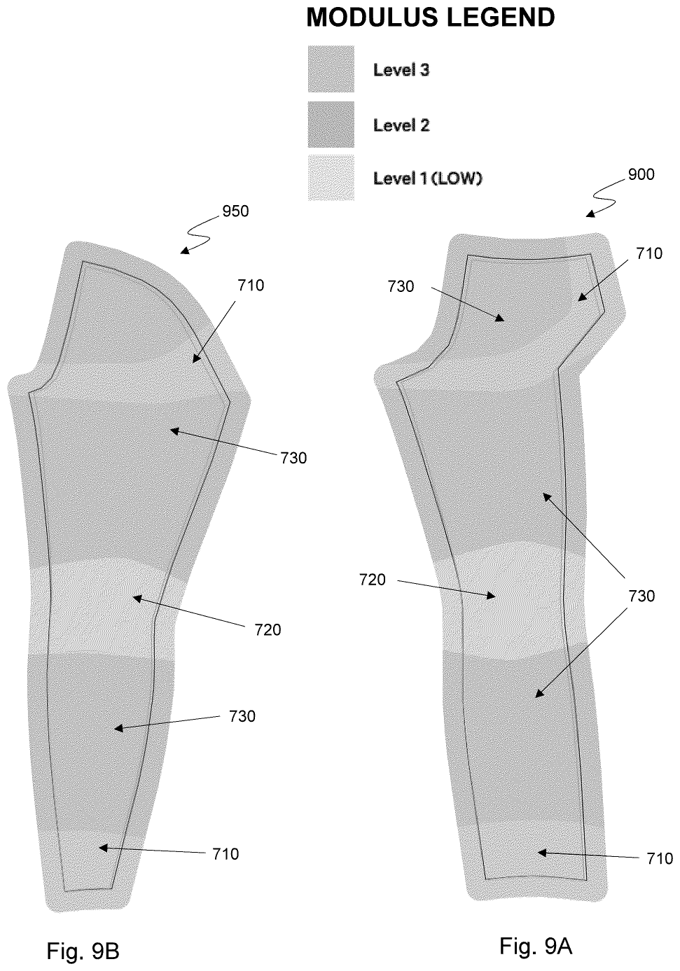

According to one embodiment, as shown in FIGS. 8, 9A, and 9B, the knitted inner liner 14 and the knitted fabric layer 16 can comprise engineered knitted panels 800, 900, 950 that may further include a third compression zone 730 attached to at least one of the first compression zone 710 and/or the second compression zone 720 by a scam or a seamless transition. The third compression zone 730 can have a third knit stitch construction (or pattern) 731 which may have a third amount of compression (or compressive modulus) (e.g., “Level 2”). According to one embodiment, the third amount of compression of the third compression zone 730 may be greater than the second amount of compression (e.g., “Level 1”) of the second compression zone 720 but less than the first amount of compression (e.g., “Level 3” or “Level 4”) of the first compression zone 710. FIG. 8 shows the engineered knitted panel 800 for positioning along the entire leg portion of the article of apparel 100. The knitted panel 800 can be engineered such that the first compression zone 710 may be positioned under the buttocks area at the back, in the pelvis area, and around the ankle area. The third compression zone 730 may be positioned in the upper leg/tight/groin area and in the shin/calf area and the second compression zone 720 may be positioned around the knee area of each leg of the article of apparel 100. The knitted panel 800 can further comprise an area with gradual compressing zones, such as for example, a first gradual compressing zone 740 which comprises alternating first and third compression zones 710, 730 to provide a smoother transition and feeling for the wearer and a second gradual compressing zone 750 which comprises alternating second and third compression zones 720, 730.

FIGS. 9A and 9B illustrate a front knitted panel 900 and the back knitted panel 950 of an article of apparel 100 (such as for example a pair of tights). The knitted panels 900, 950 can be engineered similarly to the knitted panel 800 of FIG. 8, however, the leg portions of the article of apparel 100 instead of being knitted as a single panel can have a front panel 900 and back panel 950 which can then be attached to form the article of apparel 100.

According to one embodiment, the article of apparel 100 may further include at least one ventilation zone seamlessly knitted into the knitted panels 800, 900, 950. The ventilation zone may be formed from or include a mesh or a pattern of drop stitch open holes. Advantageously, sheer and open hole mesh textures may be knit into the knitted panels 800, 900, 950 to improve breathability, to achieve a lower compressive modulus, to reduce restriction, and/or for visual effect.

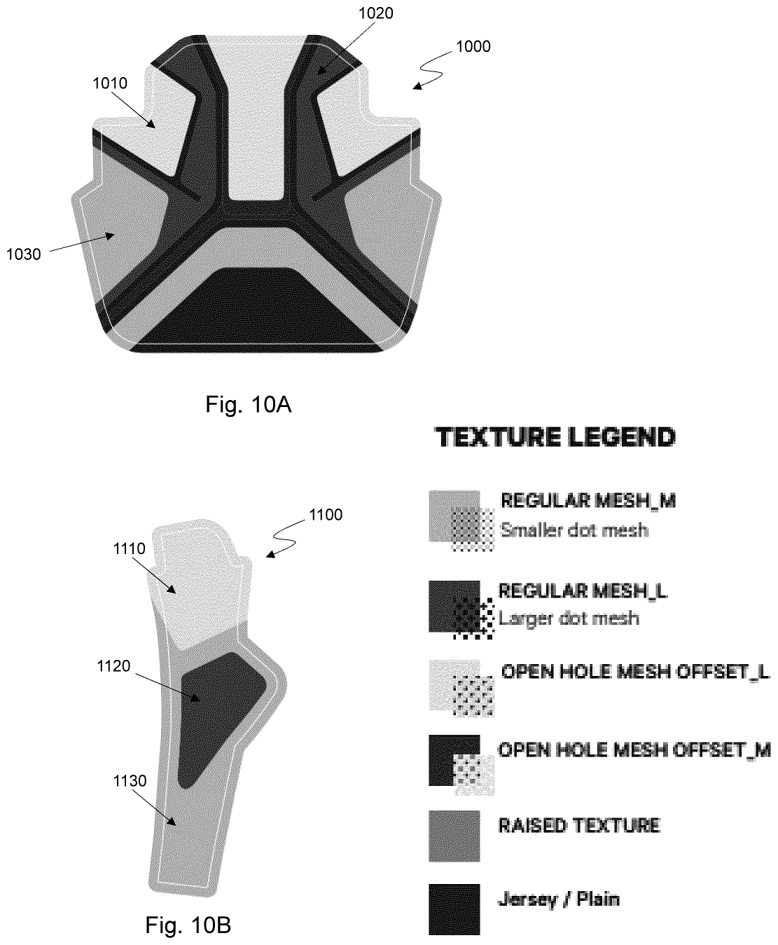

FIG. 10A illustrates the knitted inner liner 14 and knitted fabric layer 16 of the back panel of the jacket 400 shown in FIG. 4B that can be engineered to have two or more texture patterns and/or ventilation zones. FIG. 10B illustrates the knitted fabric layer 16 of the sleeve panel of the jacket 400 shown in FIGS. 4A and 4B that can also be engineered to have two or more texture patterns and/or ventilation zones. As illustrated in FIG. 10A, the engineered back knitted panel 1000 can have a first ventilation zone 1010 having large sized ventilation holes formed therein (e.g., “Open Hole Mesh Offset L”), a second ventilation zone 1020 having medium sized ventilation holes formed therein (e.g., “Regular Mesh L”), and a third ventilation zone 1030 having small sized ventilation holes formed therein (e.g., “Regular Mesh M”). Similarly, FIG. 10B shows the engineered sleeve knitted panel 1100 that can have a first ventilation zone 1110 having large sized ventilation holes formed therein, a second ventilation zone 1120 having medium sized ventilation holes formed therein, and a third ventilation zone 1130 having small sized ventilation holes formed therein. The engineered knitted panels 1000, 1100 can further comprise one or more raised textures.

While particular elements, embodiments and applications of the present application have been shown and described, it will be understood, that the scope of the application is not limited thereto, since modifications can be made by those skilled in the art without departing from the scope of the present application, particularly in light of the foregoing teachings. Thus, for example, in any method or process disclosed herein, the acts or operations making up the method/process may be performed in any suitable sequence and are not necessarily limited to any particular disclosed sequence. Elements and components can be configured or arranged differently, combined, and/or eliminated in various embodiments. The various features and processes described above may be used independently of one another, or may be combined in various ways. All possible combinations and subcombinations are intended to fall within the scope of this application. Reference throughout this disclosure to “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this application are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the application.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Any example calculations, simulations, results, graphs, values, and parameters of the embodiments described herein are intended to illustrate and not to limit the disclosed embodiments. Other embodiments can be configured and/or operated differently than the illustrative examples described herein.

1. An article of apparel having thermal regulating zones, comprising:
at least one first thermal zone comprising an outer fabric layer configured to have a low moisture regain and a knitted inner liner positioned underneath and separated from the outer fabric layer so that the knitted inner liner is facing a wearer when worn; and,
at least one second thermal zone comprising a knitted fabric layer, the second thermal zone attached to the first thermal zone;
wherein the at least one first thermal zone is positioned in a part of the article of apparel that is significantly exposed to weather elements and is configured to provide a greater level of thermal comfort to the wearer when worn than the at least one second thermal zone.

2. The article of apparel of claim 1, wherein the outer fabric layer is an outer composite fabric layer comprising a knitted face layer, a knitted back layer, and at least one middle layer having a low moisture regain fused between the knitted face layer and the knitted back layer of the outer composite fabric layer.

3. The article of apparel of claim 2, wherein the at least one middle layer in the outer composite fabric layer comprises an elastic polyurethane (PU) membrane.

4. The article of apparel of claim 2, wherein the knitted face layer of the outer composite fabric layer is a weft or warp knitted fabric comprising a first yarn and a second yarn, the first yarn being a synthetic polymer, a natural fiber, a regenerated cellulosic fiber, or a blend of natural or regenerated cellulosic fibers with synthetic fibers, the second yarn being an elastane yarn, and the knitted face layer being configured to stretch in a weft direction and/or in a warp direction.

5. The article of apparel of claim 4, wherein the knitted face layer of the outer composite fabric layer is a composite blend of a synthetic polymer plaited with an elastane.

6. The article of apparel of claim 5, wherein the first yarn of the knitted face layer is a 10-30 Denier (D) polyester yarn and the second yarn of the knitted face layer is a 10-20 D elastane yarn.

7. The article of apparel of claim 2, wherein the knitted face layer of the outer composite fabric layer comprises a durable water repellency (DWR) additive finishing.

8. The article of apparel of claim 7, wherein the DWR additive finishing comprises nonfluorinated chemicals (non-PFC).

9. The article of apparel of claim 2, wherein the knitted back layer of the outer composite fabric layer is a weft or warp knitted fabric comprising a third yarn and a fourth yarn, the third yarn being a synthetic polymer, a natural fiber, a regenerated cellulosic fiber, or a blend of natural or regenerated cellulosic fibers with synthetic fibers, the fourth yarn being an elastane yarn, and the knitted back layer being configured to stretch in a weft direction and/or in a warp direction.

10. The article of apparel of claim 9, wherein the knitted back layer of the outer composite fabric layer is a composite blend of a synthetic polymer plaited with an elastane.

11. The article of apparel of claim 10, wherein the third yarn of the knitted back layer is a 20-60 D polyester yarn and the fourth yarn of the knitted back layer is a 10-20 D elastane yarn.

12. The article of apparel of claim 1, wherein the outer fabric layer is an outer woven fabric layer.

13. The article of apparel of claim 12, wherein the outer woven fabric layer further comprises at least one elastic warp yarn and at least one elastic weft yarn.

14. The article of apparel of claim 12, wherein the outer fabric layer comprises a durable water repellency (DWR) additive finishing.

15. The article of apparel of claim 1, wherein an inner side of the knitted inner liner facing the wearer when worn is brushed.

16. The article of apparel of claim 1, wherein the knitted inner liner is a weft or warp knitted fabric comprising a fifth yarn and a sixth yarn, the fifth yarn being a synthetic polymer, a natural fiber, a regenerated cellulosic fiber, or a blend of natural or regenerated cellulosic fibers with synthetic fibers, the sixth yarn being an elastane yarn, and the knitted inner liner being configured to stretch in weft direction and/or in warp direction.

17. The article of apparel of claim 16, wherein the knitted inner liner is a composite blend of a synthetic polymer plaited with an elastane.

18. The article of apparel of claim 17, wherein the fifth yarn of the knitted inner liner is a 20-60 D polyester yarn and the sixth yarn of the knitted inner liner is a 10-20 D elastane yarn.

19. The article of apparel of claim 1, wherein the knitted inner liner comprises a durable water repellency (DWR) additive finishing.

20. The article of apparel of claim 1, wherein the knitted fabric layer of the second thermal zone is continuous and integrated with the knitted inner liner of the first thermal zone.

21. The article of apparel of claim 20, wherein an inner side of the knitted fabric layer in the second thermal zone is brushed.

22. The article of apparel of claim 1, wherein the knitted inner liner of the first thermal zone and the knitted fabric layer of the second thermal zone is a same fabric material knitted seamlessly as a single knitted panel, the outer fabric layer overlaying the knitted inner liner in the at least one first thermal zone.

23. The article of apparel of claim 22, wherein the knitted inner liner and/or the knitted fabric layer comprise a knit stitch jacquard construction having an elastane jacquard added to the knit stitch jacquard construction.

24. The article of apparel of claim 23, wherein the knitted inner liner and/or the knitted fabric layer comprise two or more compression zones integrated therein, a compression level of the two or more compression zones being changeable by changing an amount of added elastane jacquard to the knit stitch jacquard construction or by changing the knit stitch jacquard construction.

25. The article of apparel of claim 24, wherein a difference in fabric weight between one compression zone and another compression zone of the knitted inner liner and/or the knitted fabric layer is between 20 and 220 grams per square meter (GSM).

26. The article of apparel of claim 23, wherein the knitted inner liner and/or the knitted fabric layer comprise a raised texture on at least one surface of the knitted inner liner and/or the knitted fabric layer.

27. The article of apparel of claim 1, wherein the knitted inner liner of the first thermal zone and/or the knitted fabric layer of the second thermal zone comprises at least one ventilation zone seamlessly knitted into the knitted inner liner and/or the knitted fabric layer.

28. The article of apparel of claim 1, wherein the article of apparel is a tight or tights.

29. The article of apparel of claim 28, wherein the first thermal zone is positioned in at least a pelvic area and at least a portion of a front tights or groin area of the tights.

30. The article of apparel of claim 29, wherein the first thermal zone is further positioned in at least a portion of a calf area and/or at least a portion of a shin area of the tights.

31. The article of apparel of claim 28, wherein the knitted fabric liner and/or the knitted fabric layer comprise at least one gripping yarn knitted with the yarns of the knitted fabric liner and/or the knitted fabric layer to form at least one gripping area on a surface of the tights facing the wearer when worn, wherein the at least one gripping area is positioned on sides of a waistband of the tights.

32. The article of apparel of claim 1, wherein the article of apparel is a jacket.

33. The article of apparel of claim 32, wherein the first thermal zone is positioned at least in a shoulder area, a front torso area, at least a portion of an upper back area, and at least a portion of an upper arm area of the jacket.

34. The article of apparel of claim 32, wherein the knitted fabric liner and/or the knitted fabric layer comprise at least one gripping yarn knitted with the yarns of the knitted fabric liner and/or the knitted fabric layer to form at least one gripping area on a surface of the jacket facing the wearer when worn, wherein the at least one gripping area is positioned on a back and/or sides of a hem band of the jacket.

35. The article of apparel of claim 1, wherein the article of apparel is a short or shorts, wherein the first thermal zone is positioned in at least a pelvic area and in at least a portion of front leg areas of the shorts.

36. The article of apparel of claim 35, wherein the first thermal zone is further positioned in at least a portion of a back of the shorts covering a behind area.

37. The article of apparel of claim 35, wherein the knitted fabric liner and/or the knitted fabric layer comprise at least one gripping yarn knitted with the yarns of the knitted fabric liner and/or the knitted fabric layer to form at least one gripping area on a surface of the short facing the wearer when worn, wherein the at least one gripping area is positioned proximate to each leg opening of the shorts.

38. The article of apparel of claim 1, further comprising a slit or opening formed between the outer fabric layer and the knitted inner liner to allow air to flow therebetween, the outer fabric layer and the knitted inner liner being separated and spaced apart.

39. The article of apparel of claim 38, wherein the slit or opening is configured to be selectively opened and closed.

40. The article of apparel of claim 1, wherein the weather elements include rain, wind, snow, humidity, and temperature.
